(19) United States
(12) Patent Application Publication
(10) Pub. No.: US 2025/0104038 A1
(43) Pub. Date: Mar. 27, 2025

(54) SALES REGISTRATION APPARATUS AND CONTROL METHOD FOR SALES REGISTRATION APPARATUS

(71) Applicant: Toshiba Tec Kabushiki Kaisha, Tokyo (JP)

(72) Inventor: Takumaru ISHIYAMA, Mishima Shizuoka (JP)

(21) Appl. No.: 18/799,707

(22) Filed: Aug. 9, 2024

(30) Foreign Application Priority Data
Sep. 26, 2023 (JP) 2023-163078

(51) Int. Cl. G06Q 20/20; G06V 10/141

(52) U.S. Cl. CPC G06Q 20/208; G06V 10/141

(57) ABSTRACT

According to one embodiment, a sales registration apparatus for a sales registration system includes a first interface connecting to an image recognition apparatus, a second interface connecting to a point-of-sale terminal, and an imaging unit for capturing an image of an item being registered in a sales transaction. A control unit of the sales registration apparatus receives captured images from the imaging unit, transmits the captured images to the image recognition apparatus, receives a transaction completed signal from the point-of-sale terminal, and, upon receiving the transaction completed signal, causes the imaging unit to stop capturing images and/or stop transmitting captured images to the image recognition apparatus.

### CROSS-REFERENCE TO RELATED APPLICATION

This application is based upon and claims the benefit of priority from Japanese Patent Application No. 2023-163078, filed Sep. 26, 2023, the entire contents of which are incorporated herein by reference.

### FIELD

Embodiments described herein relate generally to a sales registration apparatus and a control method for a sales registration apparatus providing power savings in sales registration systems.

### BACKGROUND

Point of sales (POS) systems are used in stores where commodities or services (collectively referred to as “commodities” hereinafter) are sold. Such POS systems include scanners that read commodity codes from barcodes attached to commodities (“commodity barcodes”). Commodity barcodes may be 1-dimensional codes and 2-dimensional codes. As one example, commodity barcodes are printed on seals (stickers) and attached to commodities. As another example, commodity barcodes are printed on the packages containing commodities. POS systems register information regarding commodities to be purchased based on commodity codes read with the scanners.

As it is necessary for operators of the POS systems to search for commodity barcodes on the commodities while also possibly holding a handheld scanner or the commodity itself, operations for reading commodity codes can be troublesome. As a result, the work for registration of commodity information by operators (“commodity registration”) requires some labor. In so-called self-service POS systems, it is necessary for the customers, who may be unfamiliar with the commodity registration process, to scan the commodity barcodes. Therefore, it is desirable to improve the simplicity of commodity code reading for system operators.

In such POS systems, it is conceivable that a plurality of apparatuses configuring a system may be connected via a local area network (LAN). For an apparatus that tends to consume considerable electrical power among these plurality of apparatuses connected via the LAN, it may be desirable to perform appropriate control to reduce the processing and power loads for such apparatuses.

### BRIEF DESCRIPTION OF THE DRAWINGS

FIG. 1 is a diagram illustrating an overall configuration of a commodity information management system according to an embodiment.

FIG. 2 is a perspective view illustrating an exterior of a self-service POS system.

FIG. 3 is a block diagram of a POS terminal.

FIG. 4 is a block diagram of a scanner.

FIG. 5 is a block diagram of an image recognition apparatus.

FIG. 6 is a block diagram of a server.

FIG. 7 is a diagram illustrating a data configuration of a commodity master.

FIG. 8 is a diagram illustrating a data configuration of a comparison dictionary.

FIG. 9 is a schematic diagram illustrating functional aspects of a control unit of a POS terminal.

FIG. 10 is a schematic diagram illustrating functional aspects of a control unit of a scanner.

FIG. 11 is a schematic diagram illustrating functional aspects of a control unit of an image recognition apparatus.

FIG. 12 is a schematic diagram illustrating functional aspects of a control unit of a server.

FIG. 13 is a flowchart of operations of a POS terminal and a scanner.

FIG. 14 is a flowchart of operations of a scanner and an image recognition apparatus.

FIG. 15 is a flowchart of operations of a scanner and an image recognition apparatus.

### DETAILED DESCRIPTION

In general, embodiments describe a sales registration apparatus and a method for improving control of operations of a sales registration apparatus in a POS system for which a processing load is large. Such improvements may be related to reduced power consumption or overall system performance.

In general, according to one embodiment, a sales registration apparatus for a sales registration system includes a first interface for connecting to an image recognition apparatus, a second interface for connecting to a point-of-sale terminal, and an imaging unit for capturing an image of an item being registered in a sales transaction. A control unit of the sales registration apparatus is configured to receive captured images from the imaging unit, transmits the captured images to the image recognition apparatus, receive a transaction completed signal from the point-of-sale terminal, and, upon receiving the transaction completed signal, cause the imaging unit to stop capturing images and stop transmitting captured images to the image recognition apparatus.

Hereinafter, certain example embodiments of an information processing apparatus (a sales registration apparatus) and a control method will be described with reference to the drawings. The present disclosure is not limited to these specific examples.

### Commodity Information Management System

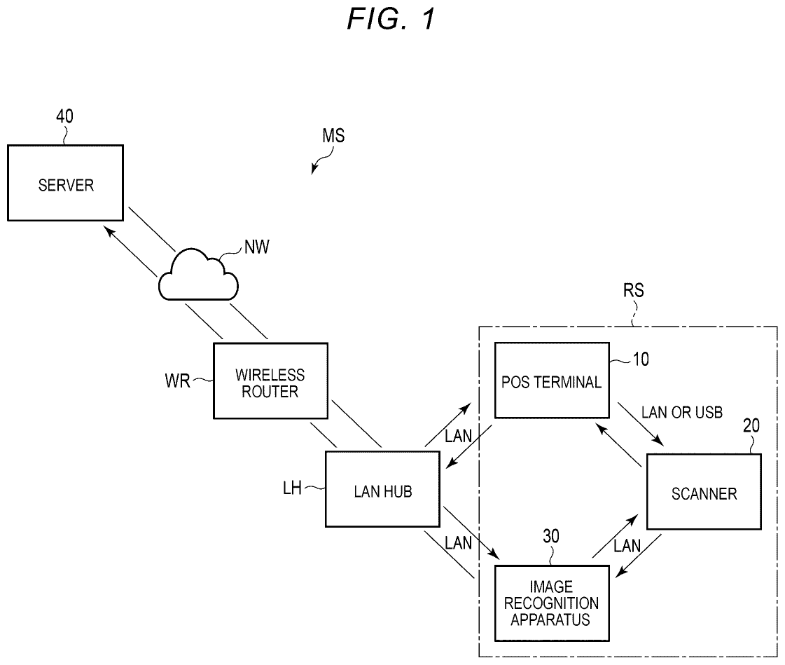

First, a commodity information management system MS according to an embodiment will be described with reference to FIG. 1. FIG. 1 is a diagram illustrating an overall configuration of the commodity information management system MS. The commodity information management system MS includes a commodity information registration system RS and a server 40.

The commodity information registration system RS includes a POS terminal 10, a scanner 20, and an image recognition apparatus 30. The POS terminal 10 and the scanner 20 are connected to be able to communicate with each other via a local area network (LAN) or a universal serial bus (USB). The scanner 20 and the image recognition apparatus 30 are connected to be able to communicate with each other via the LAN. In general, and in this example, the image recognition apparatus 30 is separate from POS terminal 10 and also the scanner 20.

In the present embodiment, Ethernet and a transmission control protocol (TCP) are combined for use in LAN communication, but a protocol for communication is not limited to this example.

The POS terminal 10 and the image recognition apparatus 30 are connected to be able to communicate through a LAN hub LH across the LAN. The LAN hub LH can be connected to communicate with wireless router WR via the LAN. The wireless router WR can then wirelessly communicate with the server 40 via a network NW.

The scanner 20 takes pictures of (images) a commodity being registered at the POS terminal 10 and acquires (captures) a commodity image. The scanner 20 transmits the acquired commodity image to the image recognition apparatus 30 via the LAN. The scanner 20 is separately able to detect and decode a commodity barcode (e.g., a 1-dimensional code or a 2-dimensional code) depicted in the acquired commodity image. That is, the scanner 20 reads information stored in the commodity barcode. A decoding result of the commodity barcode includes a commodity code stored in the commodity barcode. The scanner 20 also transmits this decoding result to the image recognition apparatus 30 via the LAN when acquired.

The image recognition apparatus 30 receives a commodity image (captured image) from the scanner 20 via the LAN. The image recognition apparatus 30 has an image or object recognition function. For example, the image recognition apparatus 30 uses a model trained through machine learning to perform image recognition (also referred to as “package recognition”) on the commodity image. Specifically, the image recognition apparatus 30 acquires feature data of an object (commodity) depicted in the commodity image by the image recognition function, compares the acquired feature data to entries in a comparison dictionary associated with different commodity codes, and can acquire a commodity code with feature data most closely matching the acquired feature data. That is, a successful image recognition result provides a commodity code for the commodity shown in the commodity image. The image recognition apparatus 30 may perform recognition on the commodity image using a method such as deep learning. The image recognition apparatus 30 transmits the image recognition result to the scanner 20 via the LAN.

The scanner 20 receives the image recognition result from the image recognition apparatus 30 via the LAN. The scanner 20 merges (compares) the code symbol decoding result and the image recognition result. Here, merging refers to acquisition of one commodity code from the decoding result and one commodity code from the image recognition result and selecting one or the other for output when necessary. That is, a merging (merged) result includes the decoded commodity barcode (i.e., the commodity code stored in the barcode) or the commodity code from the image recognition. The scanner 20 transmits the merged result to the POS terminal 10 via the LAN or the USB. The POS terminal 10 performs commodity registration based on the commodity code of the merged result received from the scanner 20.

The image recognition apparatus 30 also determines whether the commodity image received from the scanner 20 is to be used for additional learning. For example, when a difference between the acquired feature data and the feature data closest to the acquired feature data is greater than or equal to a predetermined threshold amount, the image recognition apparatus 30 determines that the commodity image received from the scanner 20 is a commodity image to be used for additional learning. The image recognition apparatus 30 transmits this commodity image (determined to be used for additional learning) and the commodity code from the barcode decoding result (received from the scanner 20) to the server 40 via the LAN.

The server 40 receives the commodity image and associated commodity code from the image recognition apparatus 30 via the LAN. The server 40 accumulates the received commodity images and commodity codes in association with each other. The server 40 performs additional learning for a model trained for commodity image recognition using the accumulated commodity image and commodity code. The server 40 subsequently updates the trained model through the additional learning. After additional learning, the server 40 updates the comparison dictionary as appropriate. An update of the comparison dictionary includes correction of an existing record (entry) or an addition of a new record (entry). The server 40 transmits the updated trained model and the updated comparison dictionary to the image recognition apparatus 30 via the LAN.

The image recognition apparatus 30 receives the updated trained model and the updated comparison dictionary from the server 40 via the LAN. The image recognition apparatus 30 updates the currently stored trained model with the updated trained model. The image recognition apparatus 30 updates the currently stored comparison dictionary with the updated comparison dictionary.

With the commodity information management system MS, it is possible to omit manual labor otherwise necessary for repeatedly collecting commodity images for additional learning of the trained model for commodity image recognition whenever a packaging of a commodity is changed.

The server 40 manages a commodity master. The POS terminal 10 transmits payment process information (information regarding a transaction subjected to a payment process) to the wireless router WR via the LAN through the LAN hub LH. The wireless router WR transmits the received payment process information to the server 40 via the network NW. The server 40 manages the commodity master based on the received payment process information. For example, the server 40 receives the payment process information from a plurality of POS terminals 10 and tracks and updates information in the commodity master according to sales (payment process) information from each of the POS terminals 10. The management of the commodity master includes correction of an existing record and addition of a new record. The server 40 transmits the commodity master appropriate for a POS terminal 10 to each POS terminal 10 via the network NW, the wireless router WR, and the LAN hub LH.

In some examples, the image recognition apparatus 30 may transmit a commodity image received from the scanner 20 to the server 40 regardless of whether the commodity image is to be used for additional learning. In such a case, a commodity image in the server 40 may be used, for example, for analyzing an image recognition state (event) in the image recognition apparatus 30.

### Commodity Information Registration System

Hereinafter, a self-service POS system that is operated by customers themselves for purchasing a commodity will be described as an example of the commodity information registration system. However, the commodity information registration system is not limited to a self-service POS system. The commodity information registration system may be a POS system that is operated by store staff.

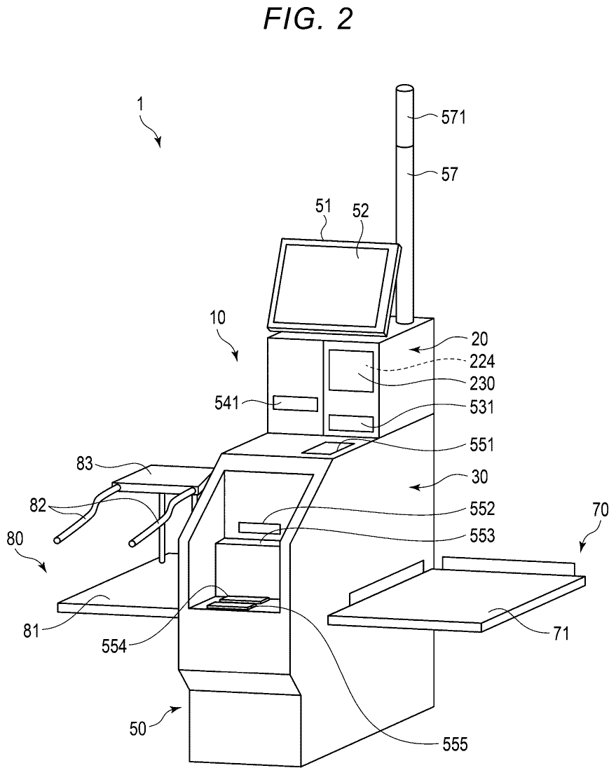

FIG. 2 is a perspective view illustrating an exterior of a self-service POS system 1. The self-service POS system 1 includes the POS terminal 10, the scanner 20 mounted on the POS terminal 10, and the image recognition apparatus 30 mounted in the POS terminal 10. Here, the self-service POS system 1 is a commodity information registration system, the POS terminal 10 is a registration apparatus, and the scanner 20 and the information recognition apparatus are 30 examples of an information processing apparatus.

The scanner 20 specifies (identifies) a commodity being purchased by a customer and transmits a commodity code of the identified commodity to the POS terminal 10. The commodity code is commodity identification information. The POS terminal 10 performs commodity registration based on the commodity code from the scanner 20 and then performs a payment process (settlement processing) for the registered commodities. The payment process is a process performed by the POS terminal 10 permitting the customer to settle (pay) a purchase price of a commodity.

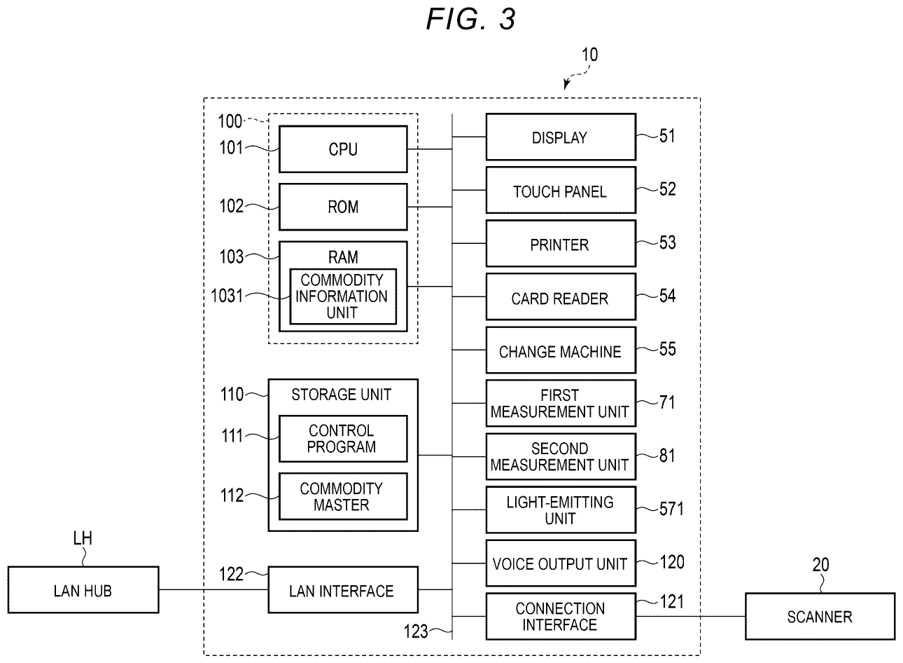

As illustrated in FIG. 2, the POS terminal 10 includes a body unit 50, a first loading stand 70, and a second loading stand 80. The body unit 50 includes a display 51 and a touch panel 52 in the upper portion and houses a printer 53, a card reader 54, and a change machine 55 inside (see FIG. 3 for each unit).

The display 51 is a display device such as a liquid crystal display (LCD) and displays various types of information to an operator (user). For example, the display 51 displays commodity information such as a commodity name and a price of a commodity that has been registered through a registration operation of the customer. The display 51 displays payment information such as a total amount due and a change due amount for the transaction during a payment operation of the customer.

The touch panel 52 is installed on the surface of the display 51 and receives user inputs according to a touched position and sends inputs to a control unit 100 (see FIG. 3) of the POS terminal 10. The customer or a manager (either of which may be referred to as an operator or a user) using the POS terminal 10 can operate the touch panel 52 by touching any of various buttons, icons, or operational keys displayed on the display 51.

As illustrated in FIG. 2, a reading window 230 for the scanner 20, a dispensing port 531 for a receipt printed by the printer 53, and a card insertion port 541 for the card reader 54 are formed below the display 51 in a direction facing the customer (or user).

The reading window 230 permits imaging (photographing) the exterior of a commodity with the scanner 20. Inside the reading window 230, an illumination unit 224 with an LED for illuminating in direction through the reading window 230 can be installed. A customer performs a commodity registration by holding a commodity to be purchased to the reading window 230. The customer may generally hold the commodity up to the reading window 230 while changing orientation or positioning of the commodity until the self-service POS system 1 successfully performs the commodity registration and a registration completion sound (tone) is generated.

The dispensing port 531 is an opening through which a receipt printed by the printer 53 is discharged. On the receipt, information (payment process information) related to a completed (settled) transaction is printed. The POS terminal 10 may be set to issue an electronic receipt instead of a paper receipt in some cases.

The card insertion port 541 is an opening through which a credit card or the like to be read by the card reader 54 is inserted. When the customer performs settlement with a credit card or the customer performs reading of a store membership card or the like, the card is inserted from the card insertion port 541.

In the body unit 50, a coin insertion port 551, a coin discharge port 552, a coin reception tray 553, a bill insertion port 554, and a bill discharge port 555 are formed to correspond to a position of the change machine 55 accommodated inside.

The coin insertion port 551 is an opening through which the customer inserts coins for settlement. The coins inserted into the coin insertion port 551 are then held in the change machine 55. The coin discharge port 552 is an opening through which coins can be dispensed from the change machine 55. The coin discharge port 552 discharges change or returns coins not accepted for payment by the change machine 55. The coin reception tray 553 is a tray that receives coins discharged from the coin discharge port 552. The bill insertion port 554 is an opening through which a customer inputs bills for settlement. The bills inserted into the bill insertion port 554 are then held in the change machine 55. The bill discharge port 555 is an opening through which bills can be discharged from the change machine 55.

The first loading stand 70 is a stand on which a shopping basket containing commodities to be purchased by a customer can be placed. The first loading stand 70 includes a first measurement unit 71. The first measurement unit 71 measures a total weight of the shopping basket placed on the first loading stand 70 and the commodities contained in the shopping basket.

The second loading stand 80 is a stand on which a shopping basket or the like for containing already scanned commodities (registered commodities) which have been transferred from a shopping basket placed on the first loading stand 70 can be placed. The second basket loading stand 80 includes a second measurement unit 81, a pair of support rods 82, and a temporary stand 83.

The second measurement unit 81 measures a total weight of items placed on the second loading stand 80. For example, if a shopping basket is placed on the second loading stand 80, the total weight of the basket and the commodities contained in the basket is measured. Or if items are placed in a shopping bag is placed on the pair of support rods 82, the total weight of the bag and commodities contained in the bag is measured. The support rods 82 are rods on which a shopping bag can be hooked and supported. The support rods 82 facilitate input of commodities into the shopping bag by supporting the shopping bag in an opened state. The temporary stand 83 is a stand on which commodities that might be easily broken or deformed, for example, tofu or eggs, can be temporarily placed. The customer can then place items on the temporary stand 83 into a shopping basket or a shopping bag to avoid breakage or the like.

The customer performs commodity registration by holding a commodity taken from the shopping basket placed on the first loading stand 70 to the reading window 230. Then, the customer puts the registered commodities on the second loading stand 80 or in a shopping bag supported by the support rods 82.

The first measurement unit 71 measures weight before and after the commodities are taken out of the shopping basket on the first loading stand 70, and then the control unit 100 (see FIG. 3) recognizes a change in the weight as items are moved. The second measurement unit 81 measures weight before and after the commodities are placed in a shopping basket or a shopping bag on the second loading stand, and thus the control unit 100 recognizes a change in the weight as items are placed on the second loading stand 80.

Based on whether the changes in the weight at first loading stand 70 are equal to (or substantially match) those at the second loading stand 80, the control unit 100 can detect whether all the commodities to be purchased by the customer have been appropriately subjected to the commodity registration process.

The body unit 50 includes a columnar pole 57 extending upward. A light-emitting unit 571 that emits light when calling a store staff member (or a manager of the POS terminal 10) is provided at an upper tip end of the pole 57.

### Hardware Configuration of POS Terminal

Next, a hardware configuration of the POS terminal 10 will be described with reference to FIG. 3. FIG. 3 is a block diagram illustrating aspects of a hardware configuration of the POS terminal 10.

The POS terminal 10 includes a control unit 100, a storage unit 110, a display 51, a touch panel 52, a printer 53, a card reader 54, a change machine 55, a first measurement unit 71, a second measurement unit 81, a light-emitting unit 571, a voice output unit 120, a connection interface 121, and a LAN interface 122. The control unit 100, the storage unit 110, the display 51, the touch panel 52, the printer 53, the card reader 54, the change machine 55, the first measurement unit 71, the second measurement unit 81, the light-emitting unit 571, the voice output unit 120, the connection interface 121, and the LAN interface 122 are connected to each other via a bus 123 or the like.

The control unit 100 includes a central processing unit (CPU) 101, a read only memory (ROM) 102, and a random access memory (RAM) 103. The CPU 101, the ROM 102, and the RAM 103 are connected to each other via the bus 123.

The CPU 101 controls the entire POS terminal 10. The ROM 102 stores various types of data and programs. The RAM 103 is used as a work area of the CPU 101. The control unit 100 performs various control processes for the POS terminal 10, for example, by having the CPU 101 execute a control program 111 from the storage unit 110 in the RAM 103.

The RAM 103 includes a commodity information unit 1031. The commodity information unit 1031 stores commodity information read from a commodity master 112 based on a commodity code acquired from the scanner 20. The commodity registration is performed by storing (registering) commodity information in the commodity information unit 1031. The commodity information stored in the commodity information unit 1031 includes such things as a commodity code, a commodity name, a price, and the like. The commodity information unit 1031 stores commodity information related to a transaction and clears the commodity information after a payment process for the transaction is completed.

The storage unit 110 can be a storage medium such as a hard disk drive (HDD) or a flash memory and stores storage content even when power is turned off. The storage unit 110 stores the control program 111 and the commodity master 112.

The control program 111 provides instructions for implementing functions, such as, transmitting an imaging start signal to the scanner 20 for enabling operation of the scanner 20 in response to an input of transaction start information on the touch panel 52, receiving a commodity code from the scanner 20, performing the commodity registration based on the received commodity code, and transmitting an imaging stop signal to the scanner 20 for disabling operation of the scanner 20 in response to an input of registration completion information indicating completion of the commodity registration of commodities in a transaction on the touch panel 52, performing a payment process for the registered commodities, and performing the setting of various operation modes of the commodity information registration system RS in response to an operation of a manager. The control program 111 may be stored in the ROM 102 instead of being stored in the storage unit 110.

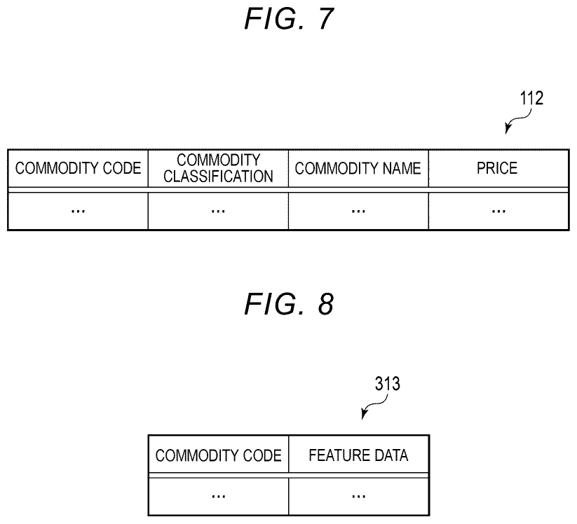

The commodity master 112 is a master file that stores commodity information regarding commodities available in a store. Since the commodities available in the store are changed daily, the commodity master 112 may be appropriately updated by a store server or the like connected via the LAN interface 122. FIG. 7 is a diagram illustrating a data configuration of the commodity master 112. The commodity master 112 includes commodity codes, commodity classification associated with the commodity codes, commodity names, and prices.

The commodity code is information identifying a commodity. The commodity classification in this context is information for classifying commodities by type or general group in the store. The commodity name is information indicating a name of the commodity. The price is information indicating the price (unit price) of the commodity. The commodity master 112 may include other pieces of information in association with the commodity codes.

Referring to FIG. 3, a hardware configuration of the POS terminal 10 will be described. The display 51 and the touch panel 52 have the above-described configurations and functions.

The printer 53 can be, for example, a thermal printer. The printer 53 prints information regarding a transaction or the like on a rolled receipt sheet and dispenses the receipt from the dispensing port 531.

The card reader 54 reads credit information necessary for settlement from a credit card inserted from the card insertion port 541. The card reader 54 reads membership information for specifying a member from a medium such as a membership card or a point card inserted from the card insertion port 541. The card reader 54 may magnetically read information from the card or may be an integrated circuit (IC) card reader that reads information from an IC card embedded with an IC chip.

The change machine 55 receives bills and coins paid in by a customer and dispenses change as necessary when the customer settles a purchase price in cash. The bills are inserted from the bill insertion port 554 and the coins are inserted from the coin insertion port 551. Bills for change are discharged from the bill discharge port 555 and coins for change are discharged from the coin discharge port 552.

The first measurement unit 71, the second measurement unit 81, and the light-emitting unit 571 have the above-described configurations and functions. The voice output unit 120 generates a sound as necessary to notify a customer of information. For example, the voice output unit 120 outputs an announcement sound or tone indicating completion of the commodity registration. The voice output unit is an example of an announcement unit.

The connection interface 121 is an interface for communication with the scanner 20 via the LAN or the USB. The control unit 100 transmits and receives information (data) to and from the scanner 20 via the LAN or the USB through the connection interface 121. For example, the control unit 100 receives a commodity code from the scanner 20 via the LAN or the USB through the connection interface 121. For example, the control unit 100 transmits data of an operation mode selected in response to an operation of the manager to the scanner 20 via the LAN or the USB through the connection interface 121.

The LAN interface 122 is an interface for communication with the LAN hub LH via the LAN. The control unit 100 transmits and receives information (data) to and from the LAN hub LH via the LAN through the LAN interface 122. For example, the control unit 100 transmits and receives the commodity master 112 to and from the server 40 via the LAN through the LAN hub LH and the wireless router WR.

The LAN interface 122 is also an interface for communication with an external apparatus such as a store server or the like managed in a store. The control unit 100 transmits and receives information to and from an external apparatus via the LAN through the LAN interface 122.

### Hardware Configuration of Scanner

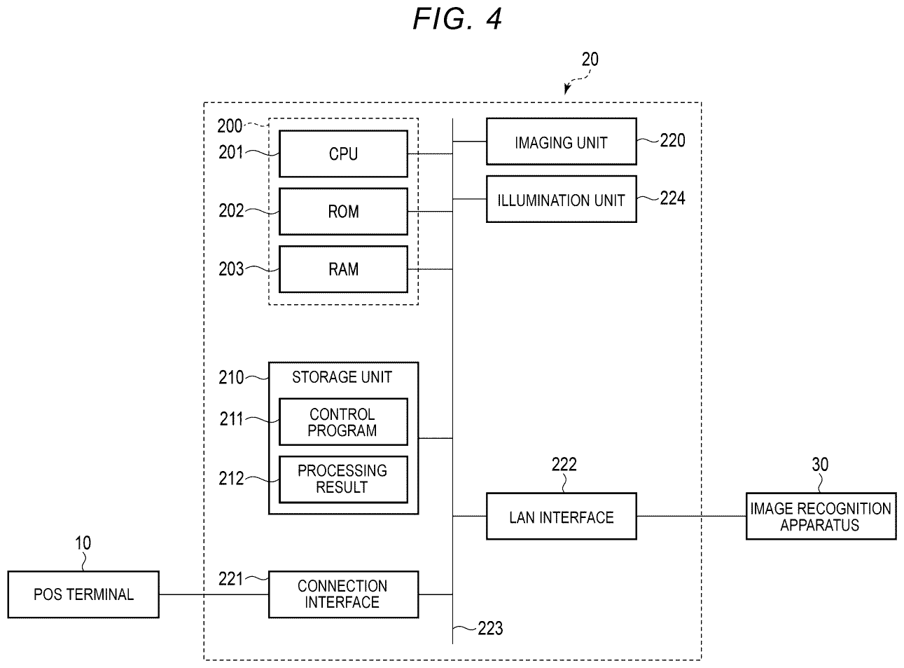

Next, a hardware configuration of the scanner 20 will be described with reference to FIG. 4. FIG. 4 is a block diagram illustrating aspects of a hardware configuration of the scanner 20.

The scanner 20 acquires a commodity image that is a captured image obtained by imaging a commodity to be purchased by the customer. The scanner 20 attempts to detect a commodity barcode in the commodity image (that is, the barcode attached to or on the imaged commodity) and decode the detected commodity barcode when possible. A decoding result from the commodity barcode provides the commodity code stored in the commodity barcode. The scanner 20 transmits the commodity image to the image recognition apparatus 30 via the LAN.

The scanner 20 includes a control unit 200, a storage unit 210, an imaging unit 220, the illumination unit 224, a connection interface 221, and a LAN interface 222. The control unit 200, the storage unit 210, the imaging unit 220, the illumination unit 224, the connection interface 221, and the LAN interface 222 are connected to each other through a bus 223 or the like.

The control unit 200 includes a CPU 201, a ROM 202, and a RAM 203. The CPU 201, the ROM 202, and the RAM 203 are connected to each other via the bus 223.

The CPU 201 controls the entire scanner 20. The ROM 202 stores various types of data and various programs. The RAM 203 is used as a work area of the CPU 201. The control unit 200 performs various control processes for the scanner 20 by having the CPU 201 execute a control program 211 from the storage unit 210 in the RAM 203.

The storage unit 210 can be a storage medium such as an HDD or a flash memory and stores storage content even when power is turned off. The storage unit 210 stores the control program 211 and a processing result 212.

The control program 211 provides instructions for implementing functions of causing the imaging unit 220 to start imaging in response to reception of a transaction start signal from the POS terminal 10, storing a frame image (captured image) obtained by imaging a commodity by the imaging unit 220 in the RAM 203, acquiring a frame image (a commodity image that is a captured image) stored in the RAM 203, detecting a commodity barcode included in the commodity image, decoding the commodity barcode, transmitting the commodity image to the image recognition apparatus 30, receiving an image recognition result from the image recognition apparatus 30, merging the decoding result and the image recognition result, a function of transmitting a commodity code (after the merging) to the POS terminal 10, stopping imaging by the imaging unit 220 in response to reception of a registration completion signal from the POS terminal 10, and the like. The control program 211 may be stored in the ROM 202 instead of being stored in the storage unit 210.

The processing result 212 can be a decoding result obtained by decoding a commodity barcode, an image recognition result obtained by the image recognition apparatus 30, or a merged result obtained from the decoding result and the image recognition result. The merged result includes a commodity barcode included in the commodity image or a commodity code of a commodity in the commodity image.

The imaging unit 220 can be, for example, by a color CCD image sensor, a color CMOS image sensor, or the like. The imaging unit 220 outputs a commodity image that is a captured image obtained by imaging a commodity over the reading window 230 under the control of the control unit 200. For example, the imaging unit 220 captures a video with a predetermined frame rate (for example, 30 fps). The imaging unit 220 stores sequentially captured frame images in the RAM 203. The frame images (commodity images) stored in the RAM 203 are used for identifying commodity codes of commodities depicted in the frame images.

Under the control of the control unit 200, the illumination unit 224 is turned on when starting imaging with the imaging unit 220 and is turned off when stopping the imaging by the imaging unit 220.

The connection interface 221 permits communication with the POS terminal 10 via the LAN or the USB. The control unit 200 transmits and receives information (data) to and from the POS terminal 10 via the LAN or the USB through the connection interface 221.

The LAN interface 222 is an interface for communication with the image recognition apparatus 30 via the LAN. The control unit 200 transmits and receives information (data) to and from the image recognition apparatus 30 via the LAN through the LAN interface 222.

The control unit 200 detects a commodity barcode included in a frame image (commodity image) stored in the RAM 203 and decodes the commodity barcode to acquire the commodity code stored in the commodity barcode. The control unit 200 transmits a frame image (commodity image) stored in the RAM 203 to the image recognition apparatus 30 through the LAN interface 222 and receives an image recognition result (commodity code) by the image recognition apparatus 30 from the image recognition apparatus 30. The control unit 200 merges the decoding result and the image recognition result, identifies the commodity barcode included in the commodity image or obtains the commodity code of the commodity depicted in the commodity image, and transmits the specified commodity code to the POS terminal 10 through the connection interface 221.

### Hardware Configuration of Image Recognition Apparatus

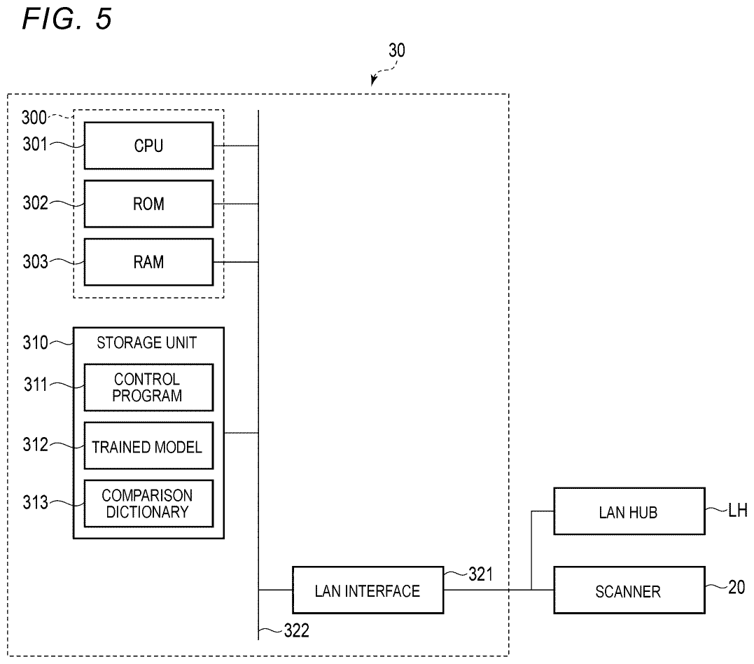

Next, a hardware configuration of the image recognition apparatus 30 will be described with reference to FIG. 5. FIG. 5 is a block diagram illustrating aspects of a hardware configuration of the image recognition apparatus 30.

The image recognition apparatus 30 receives the commodity image that is a captured image from the scanner 20 via the LAN. The image recognition apparatus 30 starts image recognition by receiving the captured image from the scanner 20 and stops the image recognition by not receiving the captured image from the scanner 20. The image recognition apparatus 30 performs the image recognition on the commodity image included in the received captured image. That is, the image recognition apparatus 30 acquires the commodity code of the commodity depicted in the commodity image based on feature data in the commodity image. The image recognition apparatus 30 transmits an image recognition result to the scanner 20 via the LAN. The image recognition apparatus 30 transmits the commodity image, or the commodity image and the commodity code to the server 40 via the LAN. The image recognition apparatus 30 receives the updated trained model and comparison dictionary from the server 40 via the LAN and updates the currently stored trained model and comparison dictionary.

The image recognition apparatus 30 includes a control unit 300, a storage unit 310, and a LAN interface 321. The control unit 300, the storage unit 310, and the LAN interface 321 are connected to each other via a bus 322 or the like.

The control unit 300 includes a CPU 301, a ROM 302, and a RAM 303. The CPU 301, the ROM 302, and the RAM 303 are connected to each other via the bus 322.

The CPU 301 controls the entire image recognition apparatus 30. The ROM 302 stores various types of data and programs. The RAM 303 is used as a work area of the CPU 301. The control unit 300 performs various control processes of the image recognition apparatus 30, for example, by having the CPU 301 execute a control program 311.

The storage unit 310 can be a storage medium such as an HDD or a flash memory and stores storage content even when power is turned off. The storage unit 310 stores the control program 311, a trained model 312, and a comparison dictionary 313.

The control program 311 provides instructions for implementing functions of receiving a commodity image that is a captured image from the scanner 20, performing image recognition on the commodity image, determining whether the image recognition is successful, transmitting an image recognition result to the scanner 20, receiving the commodity code as a decoding result from the scanner 20, determining whether the commodity image is to be used for additional learning, transmitting the commodity image alone or the commodity image and the commodity code to the server 40, receiving the updated trained model and the updated comparison dictionary from the server 40, updating the currently stored trained model with the updated trained model, and updating the currently stored comparison dictionary with the updated comparison dictionary. The control program 311 may be stored in the ROM 302 instead of being stored in the storage unit 310.

The trained model 312 is an image recognition model for performing image recognition on a commodity image (a picture of a commodity). The trained model 312 is trained through machine learning or may be adapted by additional machine learning.

The comparison dictionary 313 is a data table in which a particular commodity (commodity code) is associated with feature data related to the exterior of the commodity (e.g., the packaged commodity). FIG. 8 is a diagram illustrating a data configuration of the comparison dictionary 313. The comparison dictionary 3 includes a commodity code and feature data associated with the commodity code. Multiple instances of feature data may be associated with one commodity code in some examples. A commodity code used in the comparison dictionary 313 is the same as the commodity code in the commodity master 112.

The feature data may be, for example, data obtained by parameterizing visible features of the exterior of an item (commodity), such as a package shape, a surface color a surface texture, characteristic image patterns, or surface unevenness (roughness) on the commodity. The control unit 300 acquires the feature data from the commodity image, compares the acquired feature data to entries in the comparison dictionary, and identifies the commodity code associated in the comparison dictionary with the feature data closest to matching that from the commodity image. In other words, based on the feature data acquired from the commodity image, the control unit 300 acquires a commodity code of the commodity in the commodity image from among entries for commodities stored in advance in the comparison dictionary 313.

Referring back to FIG. 5, the hardware configuration of the image recognition apparatus 30 will be further described.

The LAN interface 321 is an interface for communication with the scanner 20 and the LAN hub LH. The control unit 300 transmits and receives information (data) to and from the scanner 20 and the LAN hub LH through the LAN interface 321.

For example, the control unit 300 receives a frame image (a commodity image) from the scanner 20 through the LAN interface 321. The control unit 300 acquires the commodity code of the commodity depicted in the commodity image and transmits the acquired commodity code to the scanner 20 through the LAN interface 321.

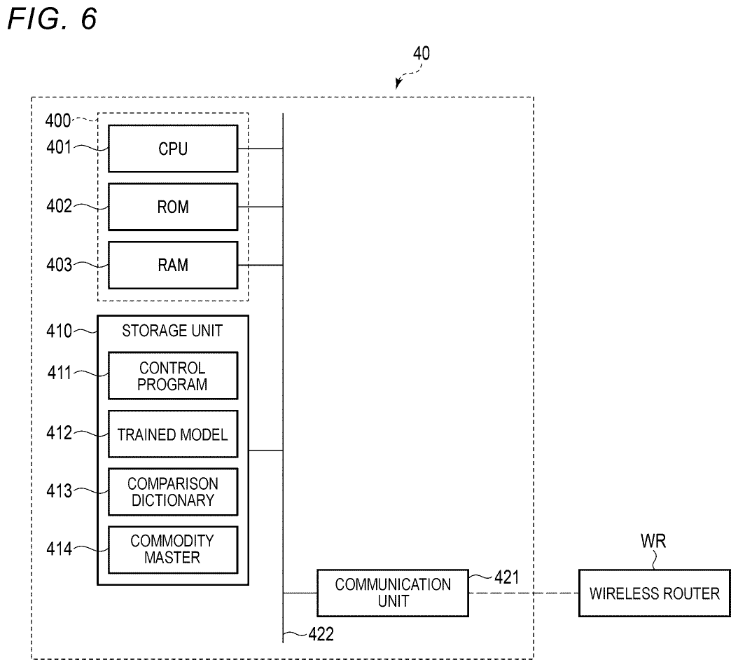

The control unit 300 transmits either a commodity image to be subjected to image recognition or the commodity image and the commodity code obtained as the decoding result from the scanner 20 to the server 40 through the LAN interface 321 as necessary. The control unit 300 may receive an updated trained model 412 (see FIG. 6) and an updated comparison dictionary 413 (see FIG. 6) from the server 40 through the LAN interface 321. The control unit 300 then updates the currently stored trained model 312 with the updated trained model 412. Likewise, the control unit 300 updates the currently stored comparison dictionary 313 with the updated comparison dictionary 413.

### Hardware Configuration of Server

Next, a hardware configuration of the server 40 will be described with reference to FIG. 6. FIG. 6 is a block diagram illustrating aspects of a hardware configuration of the server 40.

The server 40 receives commodity images and commodity codes transmitted from the image recognition apparatus 30 and accumulates the commodity images and commodity codes. The server 40 performs additional learning associated with the trained model for commodity image recognition using the accumulated commodity images and corresponding commodity codes and updates the trained model and the comparison dictionary when appropriate. The server 40 may then transmit the updated trained model and the updated comparison dictionary to the image recognition apparatus 30. The server 40 manages a commodity master. The server 40 may also receive payment process information from the POS terminal 10 and update the commodity master based on the received payment process information (sales information). The server 40 transmits a commodity master appropriate for the POS terminal 10 to each POS terminal 10.

The server 40 includes a control unit 400, a storage unit 410, and a communication unit 421. The control unit 400, the storage unit 410, and the communication unit 421 are connected to each other via a bus 422 or the like.

The control unit 400 includes a CPU 401, a ROM 402, and a RAM 403. The CPU 401, the ROM 402, and the RAM 403 are connected to each other via the bus 422.

The CPU 401 controls the entire server 40. The ROM 402 stores various types of data and programs. The RAM 403 is used as a work area of the CPU 401. The control unit 400 performs various control processes of the server 40, for example, by having the CPU 401 to execute a control program 411 in the RAM 403.

The storage unit 410 can be a storage medium such as an HDD or a flash memory and stores storage content even when power is turned off. The storage unit 410 stores the control program 411, a trained model 412, a comparison dictionary 413, and a commodity master 414.

The control program 411 provides instructions for implementing functions of receiving the commodity images and the commodity codes from the image recognition apparatus 30, accumulating the commodity images and the commodity codes, updating the trained model 412 through additional learning, updating the comparison dictionary 413, transmitting the updated trained model 412 and the updated comparison dictionary 413 to the image recognition apparatus 30, receiving the payment process information from the POS terminal 10, managing the commodity master 414, transmitting the commodity master 414 to the POS terminal 10, and transmitting the accumulated commodity images to an external apparatus as necessary. The control program 411 may be stored in the ROM 402 instead of being stored in the storage unit 410.

The trained model 412 can be trained through machine learning to perform image recognition on the commodity image. Specifically, in this context, the trained model 412 is an image recognition model for identifying a commodity depicted in a commodity image and providing the commodity code of the identified commodity. The commodity is identified by acquiring the feature data in the commodity image and comparing the acquired feature data with entries in the comparison dictionary 413.

The comparison dictionary 413 is a data table managed by associating the commodity code of a commodity with feature data corresponding to the exterior of the commodity. In general, comparison dictionary 413 is similar to the comparison dictionary 313 stored in an image recognition apparatus 30. However, the comparison dictionary 413 comprise may the comparison dictionaries 313 (or equivalents thereof) of several different image recognition apparatuses 30 in combination. The server 40 may transmit a particular comparison dictionary 313 as appropriate to each image recognition apparatus 30 individually.

The commodity master 414 includes entries for each commodity code, along with a commodity classification, a commodity name, and a price associated with each commodity code. In general, commodity master 414 is similar to a commodity master 112 stored in a POS terminal 10. However, the commodity master 414 may comprise the commodity masters 112 (or equivalents thereof) of several different POS terminals 10. The server 40 manages the commodity master 414 based on the payment process information received from the POS terminals 10. For example, the server 40 updates presently stocked numbers in the commodity master 414 based on the payment process information. The server 40 transmits the commodity master 112 appropriate for each POS terminal 10.

The communication unit 421 is an interface t for communication with the wireless router WR. The control unit 400 transmits and receives information (data) to and from the wireless router WR through the communication unit 421.

For example, the control unit 400 receives a commodity image and an image recognition result from the image recognition apparatus 30 through the communication unit 421 and accumulates the commodity images and the image recognition results. The control unit 400 performs additional learning associated with the trained model 412 using the accumulated commodity image and image recognition result and then updates the trained model 412 and the comparison dictionary 413. The control unit 400 may then transmit the updated trained model and the updated comparison dictionary to the image recognition apparatus 30 through the communication unit 421. The control unit 400 may also transmit an accumulated commodity image (or images) to an external apparatus as necessary.

The server 40 receives the payment process information from the POS terminal 10 through the communication unit 421. The server 40 manages the commodity master based on the received payment process information. The server 40 transmits a commodity master appropriate for each POS terminal 10 through the communication unit 421.

### Functional Aspects of POS Terminal

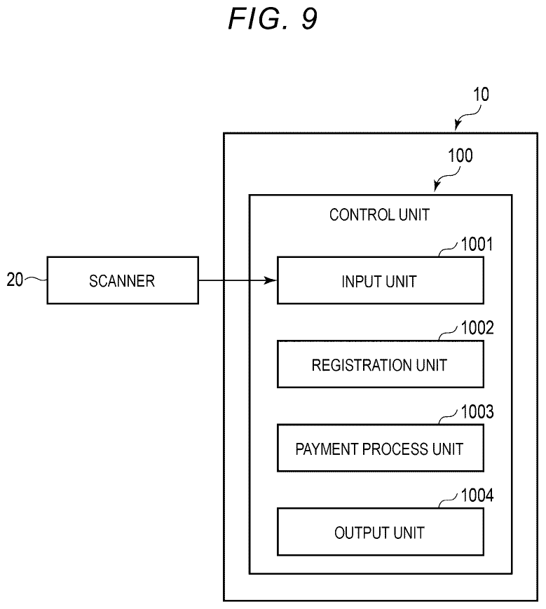

Next, functional aspects of the POS terminal 10 will be described with reference to FIG. 9. FIG. 9 is a block diagram illustrating a functional configuration of the control unit 100 of the POS terminal 10.

The control unit 100 includes an input unit 1001, a registration unit 1002, a payment process unit 1003, and an output unit 1004. The control unit 100 functions as the input unit 1001, the registration unit 1002, the payment process unit 1003, and the output unit 1004 by having the CPU 101 execute a control program stored in the ROM 102 or the storage unit 110. The functions may each be implemented via hardware such as a dedicated circuit.

Various types of information are input to the input unit 1001 from the scanner 20, the touch panel 52, the card reader 54, the first measurement unit 71, the second measurement unit 81, and the like. For example, the commodity code is input from the scanner 20 to the input unit 1001.

Information based on an operation of the touch panel 52 is input to the input unit 1001. For example, transaction start information for announcing a start of a transaction is input to the input unit 1001. Registration completion information indicating completion of the commodity registration in a transaction is input to the input unit 1001.

The registration unit 1002 performs the commodity registration for the commodities to be purchased by the customer in response to operations of the customer. In other words, the registration unit 1002 registers information regarding the commodities identified with the commodity identification information input to the input unit 1001. Specifically, the registration unit 1002 reads the commodity information from the commodity master 112 based on the commodity codes input to the input unit 1001. Then, the registration unit 1002 stores the read commodity information in the commodity information unit 1031. The commodity information is information including a commodity code, a commodity name, and a price.

The payment process unit 1003 performs a payment process for transaction settlement according to the prices of the commodities registered by the registration unit 1002. Specifically, the payment process unit 1003 performs a process of calculating a total amount (transaction amount) for the registered commodities, calculating a change due amount, displaying various types of information, and dispensing a receipt. The payment process unit 1003 can perform the payment process necessary for settlement when a customer desires a cashless settlement such as credit settlement or 2-dimensional code settlement.

The output unit 1004 provides various types of information to the scanner 20, the printer 53, the change machine 55, the light-emitting unit 571, the voice output unit 120, or the like. For example, when transaction start information is input to the input unit 1001, the output unit 1004 outputs an imaging start signal for instructing the scanner 20 to start imaging (begin acquiring pictures). When registration completion information is input to the input unit 1001, the output unit 1004 outputs an imaging stop signal for instructing the scanner 20 to stop the imaging.

When the registration unit 1002 completes the commodity registration of one commodity, the output unit 1004 outputs a control signal to the voice output unit 120 for causing an announcement sound to be output. The output unit 1004 functions as an announcement unit that indicates a successful registration by the registration unit 1002 in conjunction with the voice output unit 120. In some examples, the voice output unit 120 may be included in the scanner 20. In such a case, the voice output unit 120 may issue an announcement sound as soon as the scanner 20 identifies a commodity code.

### Functional Aspects of Scanner

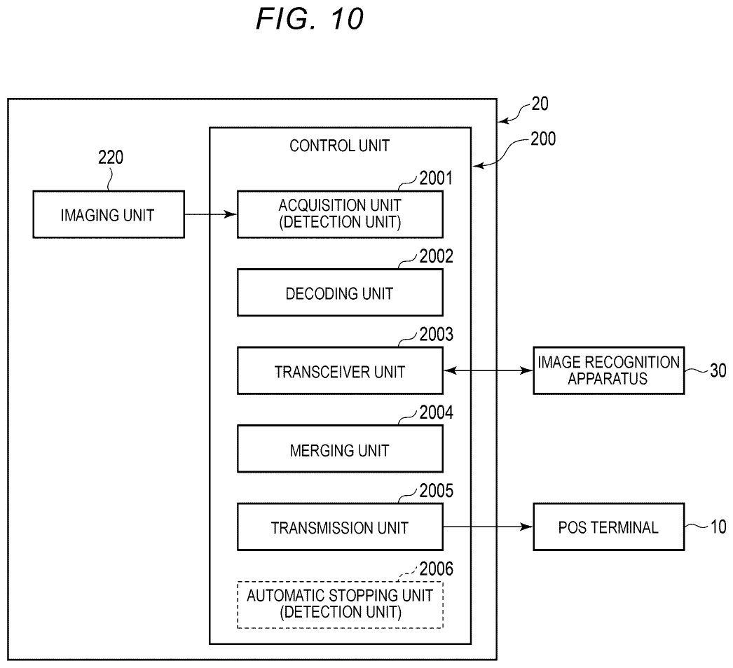

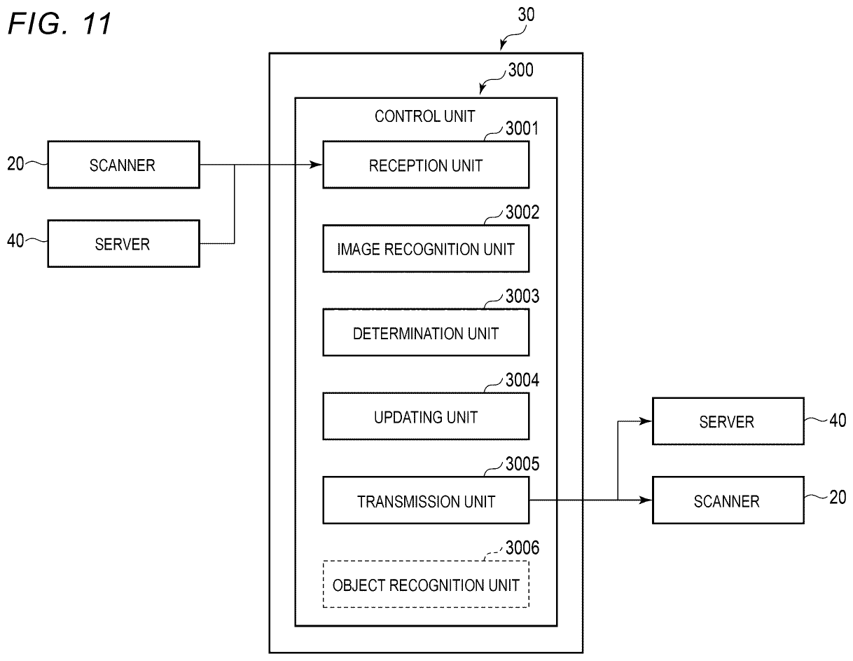

Next, functional aspects of the scanner 20 will be described with reference to FIG. 10. FIG. 10 is a block diagram illustrating functional aspects of the control unit 200 of the scanner 20.

The control unit 200 includes an acquisition unit 2001, a decoding unit 2002, a transceiver unit 2003, a merging unit 2004, a transmission unit 2005, and an automatic stopping unit 2006. The control unit 200 functions as the acquisition unit 2001, the decoding unit 2002, the transceiver unit 2003, the merging unit 2004, the transmission unit 2005, and the automatic stopping unit 2006 when the CPU 201 operates according to a control program stored in the ROM 202 or the storage unit 210. These functions may be implemented with hardware such as a dedicated circuit.

The automatic stopping unit 2006 can also be a function of the control unit 200 according to another embodiment to be described below.

The acquisition unit 2001 acquires one frame image (captured image) as a commodity image from a video captured by the imaging unit 220. The acquisition unit 2001 stores the acquired commodity image in the RAM 203. For example, the acquisition unit 2001 acquires all or some of a plurality of frame images sequentially captured by the imaging unit 220 as candidates for the commodity image, stores all or some of the acquired frame images in the RAM 203, and selects a commodity image from all or some of the stored frame images.

The acquisition unit 2001 acquires various other types of information. For example, the acquisition unit 2001 acquires an imaging start signal and an imaging stop signal from the POS terminal 10. The acquisition unit 2001 includes a detection unit that detects the start of an operation by the customer (that is, use of the customer) by acquiring the imaging start signal from the POS terminal 10 and detects the completion of an operation by the customer (that is, non-use or ending of use by the customer) by acquiring the imaging stop signal from the POS terminal 10. When the acquisition unit 2001 acquires the imaging start signal from the POS terminal 10, the imaging unit 220 starts imaging and the acquisition unit 2001 acquires a captured image from the imaging unit 220. When the acquisition unit 2001 acquires the imaging stop signal from the POS terminal 10, the imaging unit 220 stops the imaging and the acquisition unit 2001 stops acquiring the captured image.

The decoding unit 2002 detects a commodity barcode included in a commodity image (a captured image) acquired by the acquisition unit 2001 and extracts the commodity barcode from the commodity image. The decoding unit 2002 decodes the extracted commodity barcode. The decoding unit 2002 acquires the commodity code stored in the commodity barcode as a decoding result.

The transceiver unit 2003 transmits the commodity image acquired by the acquisition unit 2001 to the image recognition apparatus 30. The image recognition apparatus 30 performs image recognition on the received commodity image and transmits an image recognition result (a commodity code of a commodity in the commodity image) to the scanner 20. The transceiver unit 2003 receives an image recognition result from the image recognition apparatus 30. The transceiver unit 2003 transmits a decoding result (the commodity code stored in the commodity barcode) to the image recognition apparatus 30.

The merging unit 2004 merges the decoding result (the commodity code from the commodity barcode) and the image recognition result (the commodity code of the commodity in the commodity image). That is, the merging unit 2004 selects one commodity code from the decoding result and the image recognition result. A merged result includes the commodity code from the commodity barcode or the commodity code from the image recognition process.

The merging unit 2004 obtains the commodity code of the image recognition result as the merged result when the decoding result cannot be obtained. As a situation in which the decoding result cannot be obtained, there are cases where the customer does not correctly hold the commodity barcode in front of the imaging unit 220 of the scanner 20, or where the commodity barcode is bent, folded, or obscured.

When both the decoding result and the image recognition result are obtained and match each other, the merging unit 2004 provides the matched commodity code as the merged result. When both the decoding result and the image recognition result are obtained but do not match each other, typically the commodity code from the barcode decoding result has higher reliability and this is provided as the merged result.

The transceiver unit 2005 transmits the commodity code of the merged result to the POS terminal 10 through the connection interface 221.

### Functional Aspects of Image Recognition Apparatus

Next, functional aspects of the image recognition apparatus 30 will be described with reference to FIG. 11. FIG. 11 is a block diagram illustrating a functional aspects of the control unit 300 of the image recognition apparatus 30.

The control unit 300 includes a reception unit 3001, an image recognition unit 3002, a determination unit 3003, an updating unit 3004, a transmission unit 3005, and an object recognition unit 3006. The control unit 300 functions as the reception unit 3001, the image recognition unit 3002, the determination unit 3003, the updating unit 3004, the transmission unit 3005, and the object recognition unit 3006 when the CPU 301 operates according to a control program stored in the ROM 302 or the storage unit 310. The functions may be implemented with hardware such as a dedicated circuit.

The function of the object recognition unit 3006 can be a function of the control unit 300 according to another embodiment to be described below.

The reception unit 3001 receives a commodity image (a captured image) from the scanner 20 through the LAN interface 321. The reception unit 3001 stores the received commodity image in the RAM 303.

The image recognition unit 3002 performs image recognition on the commodity image through an image recognition function using the trained model 312. Specifically, the image recognition unit 3002 acquires feature data included in the commodity image, compares the acquired feature data with the comparison dictionary 313, and acquires a commodity code associated with feature data closest to the acquired feature data. The image recognition unit 3002 stores the acquired commodity code in the RAM 303.

The transmission unit 3005 transmits the commodity code (image recognition result) of the image recognition unit 3002 to the transceiver unit 2003 (of the scanner 20) through the LAN interface 321.

The determination unit 3003 checks whether the image recognition 3002 unit successfully performed the image recognition. For example, when a difference between the acquired feature data and the feature data closest to the acquired feature data is less than a predetermined amount, the determination unit 3003 determines that the image recognition was successful. Conversely, when the difference is greater than or equal to the predetermined amount, the determination unit 3003 determines that the image recognition failed. When the determination unit 3003 determines that the image recognition failed, the determination unit 3003 determines that the commodity image that was subjected to the failed image recognition is a commodity image to be used for additional learning.

The reception unit 3001 receives the commodity code (decoding result) from the scanner 20 through the LAN interface 321. The reception unit 3001 stores the received commodity code in the RAM 303.

When the determination unit 3003 determines that the commodity image that was subjected to the image recognition is to be used for additional learning, the transmission unit 3005 transmits the commodity image and the corresponding commodity code to the server 40 through the LAN interface 321.

The server 40 performs the additional learning of the trained model 412 using the received commodity image and commodity code, and updates the trained model 412 and the comparison dictionary 413. The server 40 transmits the updated trained model 412 and the updated comparison dictionary 413 to the reception unit 3001 of the image recognition apparatus 30 through the LAN interface 321.

The reception unit 3001 receives the updated trained model 412 and the updated comparison dictionary 413 from the server 40 through the LAN interface 321. The reception unit 3001 stores the received updated trained model 412 and updated comparison dictionary 413 in the RAM 303.

The updating unit 3004 updates the trained model 312 currently stored in the storage unit 310 with the just received updated trained model 412. The image recognition apparatus 30 updates the comparison dictionary 313 currently stored in the storage unit 310 with the just received updated comparison dictionary 413.

That is, the control unit 300 of the image recognition apparatus 30 connected to the scanner 20 via the LAN performs a process of causing the image recognition unit 3002 to recognize an image by causing the reception unit 3001 to receive a captured image from the scanner 20. The control unit 300 does not perform the process of causing the image recognition unit 3002 to recognize an image unless the reception unit 3001 receives a captured image from the scanner 20.

### Functional Aspects of Server

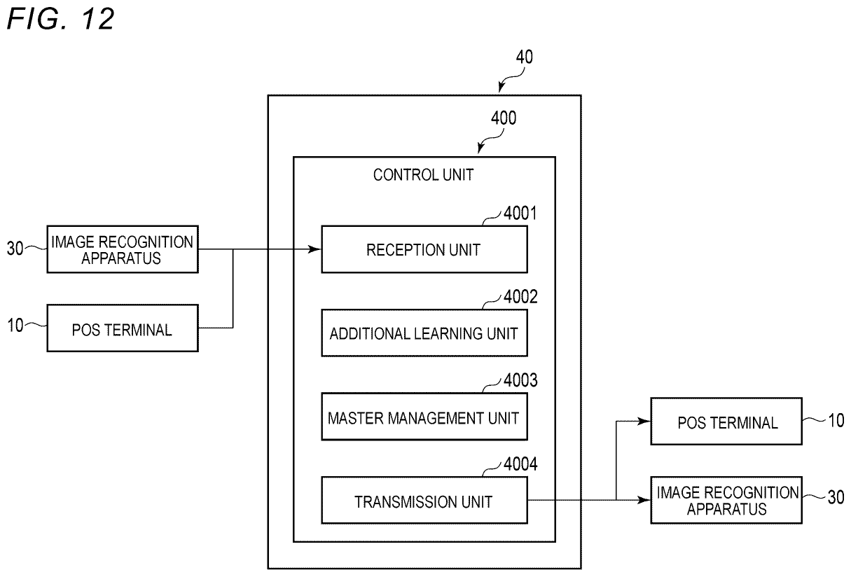

Next, functional aspects of the server 40 will be described with reference to FIG. 12. FIG. 12 is a block diagram illustrating functional aspects of the control unit 400 of the server 40.

The control unit 400 includes a reception unit 4001, an additional learning unit 4002, a master management unit 4003, and a transmission unit 4004. The control unit 400 functions as the reception unit 4001, the additional learning unit 4002, the master management unit 4003, and the transmission unit 4004 by have the CPU 401 execute a control program stored in the ROM 402 or the storage unit 410. The functions may be implemented by hardware such as a dedicated circuit.

The reception unit 4001 receives a commodity image to be used for additional learning and a commodity code of the commodity image from the image recognition apparatus 30 through the communication unit 421. The reception unit 4001 stores the received commodity image and commodity code in the RAM 403. The reception unit 4001 may store and accumulate the received commodity images in the RAM 403 or the storage unit 410 as commodity images to be used for analyzing an image recognition state (event) in the image recognition apparatus 30.

The additional learning unit 4002 performs additional learning related to the trained model 412 and updates the trained model 412 at an appropriate timing, for example, after the commodity images and the commodity codes for the additional learning have been accumulated to some arbitrary extent. After the additional learning for the trained model 412, the additional learning unit 4002 updates the comparison dictionary 413 stored in the storage unit 410.

The transmission unit 4004 then transmits the updated trained model 412 and comparison dictionary 413 as updated by the additional learning unit 4002 as an image file, a compressed file, or the like, to the reception unit 3001 of the image recognition apparatus 30 through the communication unit 421.

The reception unit 4001 receives payment process information from a POS terminal 10 through the communication unit 421. The reception unit 4001 stores the received payment process information in the RAM 403.

The master management unit 4003 manages the commodity master 414 stored in the storage unit 410 based on the received payment process information. For example, the commodity master 414 includes a store code for identifying a particular store, a separate commodity master 112 for each store code, and information such as stock availability or remaining item number for each commodity with a commodity code for each store code. The master management unit 4003 updates the commodity master 414, for example, with information regarding the remaining number of commodities based on the received payment process information.

The transmission unit 4004 transmits the commodity master 112 appropriate for a store to the POS terminal(s) 10 of the store through the communication unit 421 based on the commodity master 414 as updated by the master management unit 4003.

### Operations of POS Terminal and Scanner

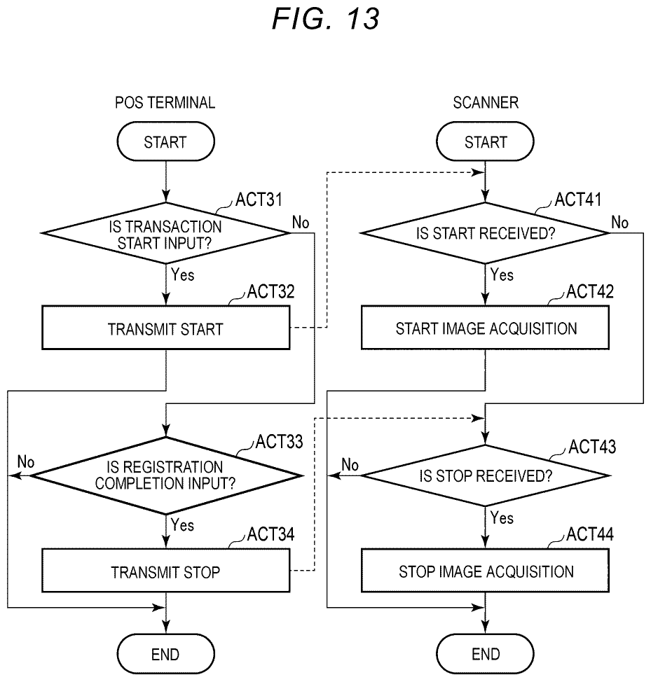

Next, operations of the POS terminal 10 and the scanner 20 related to starting imaging at the scanner 20 in response to a transaction start at the POS terminal 10 and stopping imaging at the scanner 20 in response to registration completion at the POS terminal 10 will be described with reference to FIG. 13. FIG. 13 is a flowchart of operations of the POS terminal 10 and the scanner 20 according to an embodiment. In FIG. 13, operations of the POS terminal 10 are illustrated on the left and operations of the scanner 20 are illustrated on the right. The operations of the POS terminal 10 are performed under the control of the control unit 100 executing the control program 111. The operations of the scanner 20 are performed under the control of the control unit 200 executing the control program 211.

After the POS terminal 10 receives the input of the transaction start information announcing the start of transaction via an operation on the touch panel 52 by the customer in ACT31 (Yes in ACT31), the POS terminal 10 transmits the imaging start signal to the scanner 20 (ACT32).

In ACT41, when the scanner 20 receives the imaging start signal from the POS terminal 10 (that is, use by the customer is detected) (Yes in ACT41), the scanner 20 turns on the illumination unit 224, starts (in ACT42) imaging the commodity with the imaging unit 220, and starts acquisition of a commodity image that is captured by the imaging unit 220 and transmission of images to the image recognition apparatus 30 via the LAN. The image recognition apparatus 30 starts image recognition on the captured image received from the scanner 20.

Thereafter, after the POS terminal 10 receives the input of registration completion information indicating the completion of commodity registration via an operation of the customer on the touch panel 52 in ACT33 (Yes in ACT33), the POS terminal 10 transmits the imaging stop signal to the scanner 20 in ACT34.

After the scanner 20 receives the imaging stop signal from the POS terminal 10 (that is, the customer is detected as done with the scanner 20) in ACT43 (Yes in ACT43), the scanner 20 turns off the illumination unit 224, stops the imaging unit 220, and stops acquisition and transmission of the captured images in ACT44. The image recognition apparatus 30 stops the image recognition when a captured image is not received from the scanner 20.

### Operations of Scanner and Image Recognition Apparatus

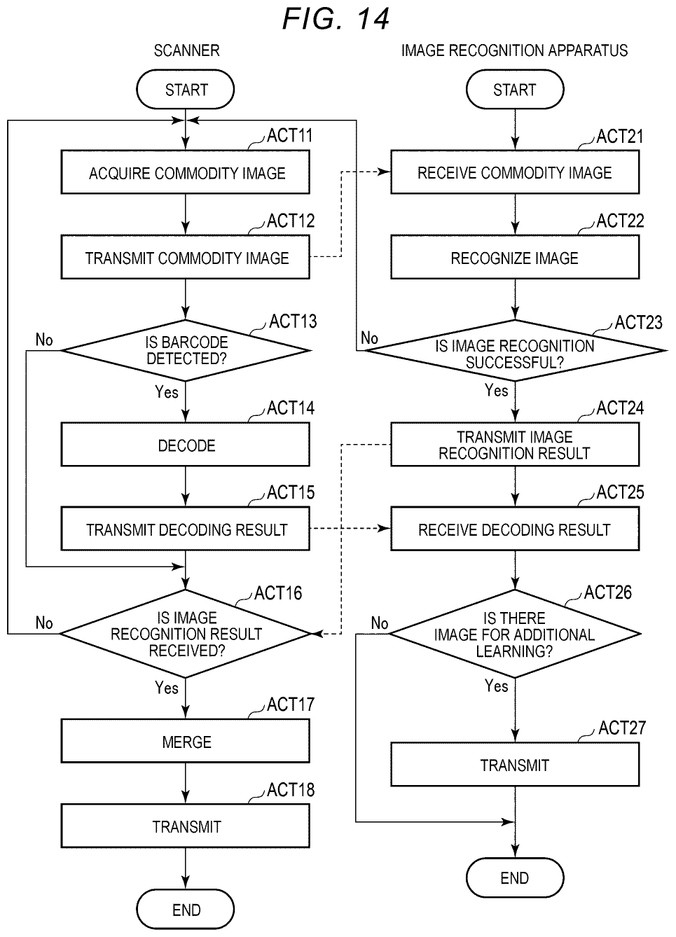

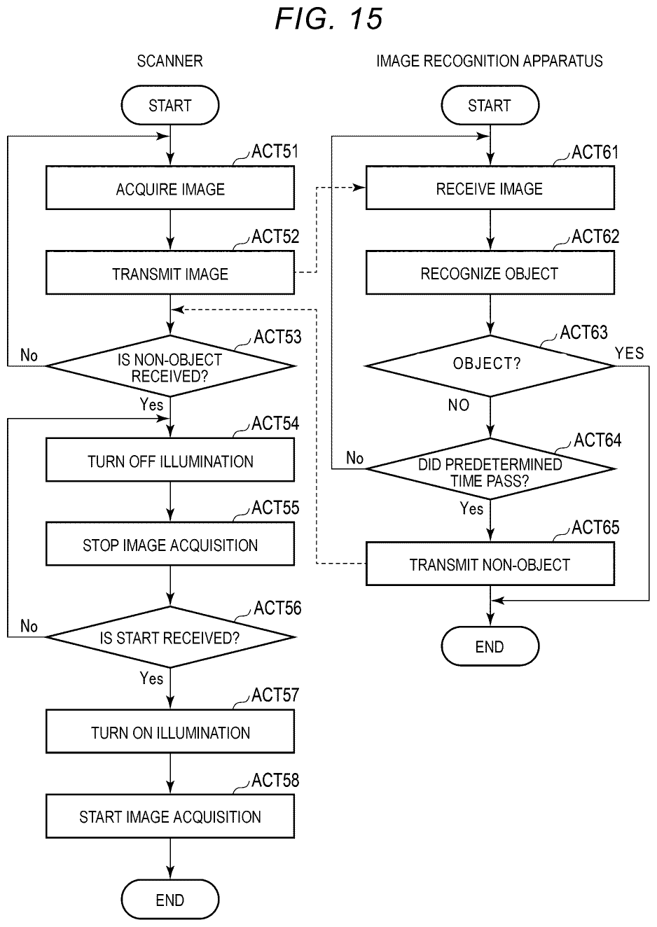

Next, operations of the scanner 20 and the image recognition apparatus 30 will be described with reference to FIG. 14. FIG. 14 is a flowchart of operations of the scanner 20 and the image recognition apparatus 30 according to an embodiment. In FIG. 14, operations of the scanner 20 are illustrated on the left and operations of the image recognition apparatus 30 are illustrated on the right. The operations of the scanner 20 are performed under the control of the control unit 200 executing the control program 211. The operations of the image recognition apparatus 30 are performed under the control of the control unit 300 executing the control program 311.

In ACT11, the scanner 20 acquires a commodity image (captured image) from a video (video stream) provided by the imaging unit 220. For example, the scanner 20 stores some or all of a plurality of frame images sequentially captured by the imaging unit 220 as candidates for the commodity image in the RAM 203. Subsequently, the scanner 20 selects one frame image among the plurality of frame images stored in the RAM 203. Typically, the scanner 20 assigns an identification code to the commodity image, however, for convenience in this explanation, it can be assumed that the commodity image includes the identification code as a part thereof.

In ACT12, the scanner 20 transmits the commodity image to the image recognition apparatus 30 via the LAN, for example, through TCP communication.

In ACT21, the image recognition apparatus 30 receives the commodity image (and its identification code) from the scanner 20 via the LAN. The image recognition apparatus 30 stores the received commodity image in the RAM 303.

In ACT22, the image recognition apparatus 30 performs the image recognition on the commodity image. For example, the image recognition apparatus 30 performs the image recognition based on feature data such as contours, colors, or the like in the commodity image. Here, the image recognition apparatus 30 first acquires the feature data included in the commodity image by image analysis of the like. Subsequently, the image recognition apparatus 30 searches for the feature data of entry closest to the acquired feature data by comparing the acquired feature data with the comparison dictionary 313. Subsequently, the image recognition apparatus 30 acquires the commodity code associated with feature data closest to the acquired feature data (a search result).

In ACT23, the image recognition apparatus 30 determines whether the image recognition was successful. For example, the image recognition apparatus 30 calculates a difference (a difference value) between the acquired feature data and the feature data closest to the acquired feature data. Subsequently, the image recognition apparatus 30 compares the difference (difference value) to some predetermined amount (threshold level).

When the difference is less than the predetermined amount, the image recognition apparatus 30 determines that the image recognition is successful. Here, the image recognition apparatus 30 stores the commodity code acquired in ACT22 as an image recognition result in the RAM 303. Thereafter, the operation proceeds to an operation of ACT24.

Conversely, when the difference is greater than or equal to the predetermined amount, the image recognition apparatus 30 determines that the image recognition failed. Here, the image recognition apparatus 30 requests the scanner 20 to acquire and transmit another commodity image and then performs operations of ACT21 to ACT23 again. The image recognition apparatus 30 determines that the commodity image subjected to the image recognition that can be a commodity image to be used for additional learning.

In ACT24, the image recognition apparatus 30 transmits an image recognition result stored in the RAM 303 to the scanner 20 via the LAN. The image recognition apparatus 30 transmits the identification code to the scanner 20.

In ACT13, the scanner 20 attempts to detect the commodity barcode in the commodity image. In other words, the scanner 20 checks whether the commodity barcode is visible in the commodity image.

When the commodity barcode is detected in ACT13 (Yes in ACT13), the scanner 20 extracts and then decodes, in ACT14, the detected commodity barcode and provides the commodity code stored in the commodity barcode as a decoding result. The scanner 20 stores the acquired commodity code in the RAM 203.

Subsequently, in ACT15, the scanner 20 transmits the commodity code (barcode decoding result) to the image recognition apparatus 30. The operations of ACT14 and ACT15 are operations that occur only if the commodity barcode is detected in ACT13. In some cases, the scanner 20 does not transmit a commodity code from the barcode decoding such as when no barcode is present on the commodity or otherwise.

In ACT16, the scanner 20 verifies whether the image recognition result for the commodity image (the commodity code of the commodity in the commodity image) was received from the image recognition apparatus 30. When an image recognition result is received (Yes in ACT16), the scanner 20 stores the received image recognition result in the RAM 203. The scanner 20 may specify the commodity image corresponding to the image recognition result based on an identification code received along with the image recognition result. Thereafter, the operation proceeds to a merging operation of ACT17.

When the commodity barcode cannot be detected in ACT13 (No in ACT13), the operations of ACT14 and ACT15 are skipped and the operation proceeds to verifying reception of the image recognition result in ACT16.

When the image recognition result is not received in ACT16 (No in ACT16), the scanner 20 repeatedly performs (attempts) the operations of ACT11 and ACT13 to ACT15. Here, the image recognition apparatus 30 may omit the transmission of the commodity image in ACT12 since a new commodity image might not be necessary. That is, until an image recognition result is received from the image recognition apparatus 30, the scanner 20 continues a series of regular operations for the acquisition of the commodity image in ACT11, the detection of the commodity barcode in ACT13, the decoding in ACT14, and the transmission of the commodity code (decoding result) in ACT15.

In ACT17, the scanner 20 merges the decoding result (the commodity code from the commodity barcode) and the image recognition result (the commodity code of the commodity recognized in the commodity image). In this merging process, the scanner 20 acquires (selects) the one commodity code considered to be most correct between the decoding result and the image recognition result.

When a decoding result is not obtained, the commodity code from the image recognition is the merged result. The decoding result might not be obtained in various situations, such as, there are cases where the customer does not correctly hold the commodity barcode towards the imaging unit 220 of the scanner 20, or the commodity barcode is unnaturally bent, folded, defaced, or the like.

When both a decoding result and an image recognition result are obtained, the scanner 20 compares the decoding result to the image recognition result. When the decoding result matches the image recognition result, the scanner 20 supplies the matched commodity code as the merged result. Conversely, when the decoding result does not match the image recognition result, the scanner 20 generally uses the commodity code from the more reliable decoding process as the merged result.

In ACT18, the scanner 20 transmits the merged result (the one commodity code considered to be most correct) to the POS terminal 10.

In ACT16 to ACT18 according to an embodiment, the scanner 20 receives the image recognition result from the image recognition apparatus 30 (Yes in ACT16), and then uploads (transmits) the commodity code obtained by the merging process to a host apparatus (here, the POS terminal 10) as an example. However, when the commodity code obtained by decoding the commodity barcode is transmitted to the host apparatus (POS terminal 10) before the image recognition result is received from the image recognition apparatus 30 but then the image recognition result is later sent from the image recognition apparatus 30, the scanner 20 may still transmit the commodity code obtained by merging to the host apparatus.

When the scanner 20 transmits the commodity code (decoding result) in ACT15, the image recognition apparatus 30 receives this commodity code in ACT25. The image recognition apparatus 30 stores the received commodity code (decoding result) in the RAM 303.

In ACT26, the image recognition apparatus 30 checks whether there is a commodity image to be used for additional learning. For example, when there is a commodity image for which the image recognition failed in ACT23 but the commodity code (barcode decoding result) is received from the scanner 20 in ACT25, the image recognition apparatus 30 determines that there is a commodity image to be used for additional learning.

When, in ACT26 there is a commodity image to be used for additional learning, the image recognition apparatus 30 transmits the commodity image and the corresponding commodity code that was stored in the RAM 303 to the server 40 in ACT27.

When it is determined in ACT26 that there is no commodity image to be used for additional learning, the operation of ACT27 is skipped and the operation ends.

### Summary of Embodiment

In a commodity information registration system RS according to an embodiment, the scanner 20 starts imaging a commodity upon receiving the imaging start signal at the start of a transaction at the POS terminal 10 and begins acquisition of commodity images (captured images) and transmission of the commodity images to the image recognition apparatus 30 via the LAN. The image recognition apparatus 30 starts image recognition on a commodity image received from the scanner 20.

The scanner 20 stops imaging upon receiving the imaging stop signal at completion of the commodity registration process for the transaction at the POS terminal 10 and ends acquisition and transmission of the commodity images. The image recognition apparatus 30 then stops the image recognition process when not receiving a captured image from the scanner 20.

In the image recognition process performed by the image recognition apparatus 30, the processing load (effort) is typically large, as is power consumption. However, when the image recognition apparatus 30 is connected as an external apparatus to the scanner 20 via the LAN, the operation does not need to always be executed and the operation can be performed just during the transaction (that is, during use by the customer). Thus, it is possible to implement power saving and increase the lifespan of the image recognition apparatus 30.

Accordingly, it is possible to appropriately control an operation of an apparatus for which the processing load is large among of the various apparatuses included in the system.

### Another Embodiment

In this second embodiment, the commodity information registration system RS is configured to perform operations as in the flowchart of FIG. 14. In this example, aspects after an initial start-up at the opening of a store (that is, after starting of the system) but before an input of transaction start information at the POS terminal 10 (that is, in a ready mode) will be described.

In the ready mode, a customer does not hold a commodity to the reading window 230 of the scanner 20. Therefore, an actual commodity image is not included in a captured image acquired by the scanner 20 and transmitted to the image recognition apparatus 30. The image recognition apparatus 30 performs an image recognition process on the received captured image, which causes unnecessary power consumption and deterioration in a lifespan. In the flowchart of FIG. 14, the scanner 20 repeats a process including ACT11-ACT13 to ACT16 then back to ACT11 and the image recognition apparatus 30 enters a repetition state including the process of ACT21-ACT23.

Therefore, in the ready mode of the commodity information registration system RS, it is possible to achieve power saving and longer lifespan of the image recognition apparatus 30 by operating the scanner 20 and the image recognition apparatus 30 as in this second embodiment.

The image recognition apparatus 30 according to the second embodiment provides the object recognition unit 3006 as a function of the control unit 300, as illustrated in FIG. 11.

The object recognition unit 3006 recognizes whether any object is depicted in the captured images received from the scanner 20. Specifically, it can be recognized whether a certain object (object image) is within an imaging range (a variable range of a focal point) through the reading window 230 of the imaging unit 220 of the scanner 20. When an object image is not detected in a captured image of the scanner 20 for some predetermined time (for example, a few minutes), the transmission unit 3005 transmits a non-object signal indicating that there is no object within the imaging range of the scanner 20.

The scanner 20 according to the second embodiment includes automatic stopping unit 2006 as a functional aspect of the control unit 200, as illustrated in FIG. 10.

When the transceiver unit 2003 receives the non-object signal from the image recognition apparatus 30, the automatic stopping unit 2006 turns off the illumination unit 224 and stops the imaging by the imaging unit 220 and acquisition of captured images by the acquisition unit 2001. The automatic stopping unit 2006 turns on the illumination unit 224 and starts imaging by the imaging unit 220 whenever the acquisition unit 2001 receives an imaging start signal from the POS terminal 10. The automatic stopping unit 2006 includes a detection unit that detects non-use when the transceiver unit 2003 receives the non-object signal from the image recognition apparatus 30 and detects start of a user operation (that is, use by the user) when the acquisition unit 2001 acquires the imaging start signal from the POS terminal 10.

FIG. 15 is a flowchart of operations of the scanner 20 and the image recognition apparatus 30 according to the second embodiment. In FIG. 15, operations of the scanner 20 are illustrated on the left and operations of the image recognition apparatus 30 are illustrated on the right. The operations of the scanner 20 are performed under the control of the control unit 200 executing control program 211. The operations of the image recognition apparatus 30 are performed under the control of the control unit 300 executing control program 311.

In a ready the commodity information mode of registration system RS, the scanner 20 acquires a captured image from the imaging unit 220 in ACT51 and the scanner 20 transmits the acquired captured image to the image recognition apparatus 30 in ACT52.

When the image recognition apparatus 30 receives the captured image from the scanner 20 in ACT61, the image recognition apparatus 30 can recognize, in ACT62, whether an object image is included in the received captured image. Here, the commodity image is not included in the captured image, but the image recognition apparatus 30 performs the image recognition process in ACT21 to ACT23 of the flowchart of FIG. 14.

When the image recognition apparatus 30 recognizes, in ACT63, that the object image is not included in the captured image (No in ACT63), the image recognition apparatus 30 determines in ACT64 whether a predetermined time has passed without detection of an object (object image) in the captured image.

When the image recognition apparatus 30 determines in ACT64 that the predetermined time has passed without detection of the object (Yes in ACT64), the image recognition apparatus 30 transmits the non-object signal (indicating that there is no object detected) to the scanner 20 in ACT65.

When the scanner 20, in ACT53, receives the non-object signal from the image recognition apparatus 30 (that is, non-use of the user is detected) (Yes in ACT53), the scanner 20 turns off the illumination unit 224 in ACT54 and stops the imaging and the acquisition of the captured images by the imaging unit 220 in ACT55. That is, the scanner 20 stops transmitting captured images to the image recognition apparatus 30. Thus, the image recognition apparatus 30 will not receive a captured image from the scanner 20. Therefore, the image recognition process in the image recognition apparatus 30 in ACT21 to ACT23 of the flowchart of FIG. 14 is not performed.

When the scanner 20, in ACT56, receives the imaging start signal from the POS terminal 10 in response to an input of the transaction start information at the POS terminal 10 (that is, use of the user is detected) (Yes in ACT56), the scanner 20 turns on the illumination unit 224 in ACT57. In ACT58, the scanner 20 starts imaging of a commodity in the imaging unit 220 and starts acquisition of the commodity image that is the captured image and transmission of the commodity image to the image recognition apparatus 30.

The processing of the scanner 20 in ACT56 to ACT58 corresponds, in general, to the processing of the scanner 20 in ACT41 and ACT42 in the flowchart of FIG. 13. In these processes, the scanner 20 and the image recognition apparatus 30 begin a process of attempting to identify a commodity code on a commodity in a commodity image that was captured by the scanner 20.

### Summary of Second Embodiment

In the commodity information registration system RS according to the second embodiment, if the image recognition apparatus 30 is in the ready mode for object recognition after a system start and a predetermined time passes without an object being detected as included in the captured images from the scanner 20, the scanner turns off the illumination unit 224 and switches to an auto power off mode (e.g., a powered down mode, a lower power mode, or a power-saving mode). In this mode, the scanner 20 stops the imaging by the imaging unit 220 and stops the acquisition of captured images and the transmission of the captured images to the image recognition apparatus 30, until an imaging start signal is received after an input of transaction start information at the POS terminal 10. The image recognition apparatus 30 also stops the image recognition processing when no captured image is received from the scanner 20.

Thus, when in a ready mode, the operation of the image recognition apparatus 30 can be stopped after some period of non-use of the scanner 20 at the POS terminal 10, and thus it is possible to implement power saving and provide a longer lifespan for the image recognition apparatus 30 even though the image recognition apparatus may be an external apparatus rather than under direct control or integrated with the POS terminal 10 or the scanner 20.

Accordingly, it is possible to appropriately control a high processing load apparatus among a plurality of apparatuses included in the system.

### Others

In certain embodiments, the control programs executed by the POS terminal 10, the scanner 20, the image recognition apparatus 30, and the server 40 may be stored and provided on a non-transitory, computer-readable medium such as a CD-ROM. The control programs executed by the POS terminal 10, the scanner 20, the image recognition apparatus 30, and the server 40 according to the foregoing embodiments may be stored on a computer connected to a network, such as the Internet, and may be provided by downloading via the network or otherwise provided or distributed across a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sales registration apparatus for a sales registration system, the apparatus comprising:
a first interface for connecting to an image recognition apparatus;
a second interface for connecting to a point-of-sale terminal;
an imaging unit for capturing an image of an item being registered in a sales transaction; and
a control unit configured to:
receive captured images from the imaging unit,
transmit the captured images to the image recognition apparatus,
receive a transaction completed signal from the point-of-sale terminal, and
upon receiving the transaction completed signal, cause the imaging unit to stop capturing images and stop transmitting captured images to the image recognition apparatus.

2. The sales registration apparatus according to claim 1, wherein the control unit is further configured to:
determine if an encoded commodity code is depicted in a captured image received from the imaging unit,
decode the encoded commodity code, and
output a decoded commodity code to the point-of-sale terminal.

3. The sales registration apparatus according to claim 2, wherein the control unit is further configured to:
output the decoded commodity code to the image recognition apparatus in association with the captured image.

4. The sales registration apparatus according to claim 1, wherein the imaging unit comprises a charge-coupled device.

5. The sales registration apparatus according to claim 1, wherein the imaging unit is mounted in the point-of-sale terminal.

6. The sales registration apparatus according to claim 1, wherein the control unit is further configured to:
receive a non-object detection signal from the image recognition apparatus, and
upon receiving the non-object detection signal, cause the imaging unit to stop capturing images and stop transmitting captured images to the image recognition apparatus.

7. The sales registration apparatus according to claim 6, wherein
the imaging unit includes an illumination source, and
the control unit is further configured to:
upon receiving the non-object detection signal, cause the illumination source to turn off.

8. The sales recognition apparatus according to claim 1, wherein
the imaging unit includes an illumination source, and
the control unit is further configured to:
upon receiving the transaction completed signal, cause the illumination source to turn off.

9. A sales registration system, comprising:
a point-of-sale terminal at which a user can register items for purchase in a sales transaction;
an image recognition apparatus; and
a scanner apparatus including:
a first interface connected to the image recognition apparatus;
a second interface connected to the point-of-sale terminal;
an imaging unit for capturing an image of an item being registered for purchase in the sales transaction; and
a control unit configured to:
receive captured images from the imaging unit,
transmit the captured images to the image recognition apparatus,
receive a transaction completed signal from the point-of-sale terminal, and
upon receiving the transaction completed signal, cause the imaging unit to stop capturing images and stop transmitting captured images to the image recognition apparatus.

10. The sales registration system according to claim 9, wherein the control unit is further configured to:
determine if an encoded commodity code is depicted in a captured image received from the imaging unit,
decode the encoded commodity code, and
output a decoded commodity code to the point-of-sale terminal.

11. The sales registration system according to claim 9, wherein the imaging unit is mounted in the point-of-sale terminal.

12. The sales registration system according to claim 9, wherein the control unit is further configured to:
receive a non-object detection signal from the image recognition apparatus, and
upon receiving the non-object detection signal, cause the imaging unit to stop capturing images and stop transmitting captured images to the image recognition apparatus.

13. The sales registration system according to claim 12, wherein
the imaging unit includes an illumination source, and
the control unit is further configured to:
upon receiving the non-object detection signal, cause the illumination source to turn off.

14. The sales registration system according to claim 9, wherein
the imaging unit includes an illumination source, and
the control unit is further configured to:
upon receiving the transaction completed signal, cause the illumination source to turn off.

15. A control method for a sales registration apparatus, the control method comprising:
receiving captured images from an imaging unit;
transmitting the captured images to an image recognition apparatus;
receiving a transaction completed signal from a point-of-sale terminal; and
upon receiving the transaction completed signal, causing the imaging unit to stop capturing images and stop transmitting captured images to the image recognition apparatus.

16. The control method according to claim 15, further comprising:
determining if an encoded commodity code is depicted in a captured image received from the imaging unit;
decoding the encoded commodity code; and
outputting a decoded commodity code to the point-of-sale terminal.

17. The control method according to claim 16, further comprising:
outputting the decoded commodity code to the image recognition apparatus in association with the captured image.

18. The control method according to claim 15, further comprising:
receiving a non-object detection signal from the image recognition apparatus; and
upon receiving the non-object detection signal, causing the imaging unit to stop capturing images and stop transmitting captured images to the image recognition apparatus.

19. The control method according to claim 18, further comprising:
upon receiving the non-object detection signal, causing an illumination source in the imaging unit to turn off.

20. The control method according to claim 15, further comprising:
upon receiving the transaction completed signal, causing an illumination source in the imaging unit to turn off.
